(19) United States
(12) Patent Application Publication
(10) Pub. No.: US 2015/0262175 A1
(43) Pub. Date: Sep. 17, 2015

(54) PAYMENT TERMINAL DEVICE AND PAYMENT PROCESSING METHOD

(71) Applicant: PANASONIC INTELLECTUAL PROPERTY MANAGEMENT CO., LTD., Osaka (JP)

(72) Inventors: Takeshi NINOMIYA, Osaka (JP); Yoshihide NAKASHIMA, Fukuoka (JP)

(21) Appl. No.: 14/640,560

(22) Filed: Mar. 6, 2015

(30) Foreign Application Priority Data
Mar. 11, 2014 (JP) 2014-047867

(51) Int. Cl. G06Q 20/40; G06Q 20/30

(52) U.S. Cl. CPC G06Q 20/40; G06Q 20/30

(57) ABSTRACT

In the payment process of a transaction, it is possible to ensure security of information regarding the payment process, and perform a suitable payment process. When mutual authentication is established, a secure input application and a command interpreter form a secure virtual private communication path (VPN). Transmission of payment-related information such as encrypted PIN information is started through the VPN. The command interpreter and a payment center form a secure virtual private communication path (VPN). Transmission of payment-related information is started through the VPN. When transmission using the VPNs and is normal, a secure input manager and a terminal UI payment application perform a card payment process in which the command interpreter is relayed.

### BACKGROUND OF THE INVENTION

1. Field of the Invention

The present disclosure relates to a payment terminal device and a payment processing method, which are used to perform procedures of a payment process in a transaction.

2. Description of the Related Art

For example, in (credit) transactions of goods or services using a credit card, safety (security) of the transaction is ensured by confirming (identifying) whether or not a person who performs the transaction is the owner of the credit card used for the transaction. This identification is performed by customers signing a transaction slip with transaction contents printed thereon during the payment process of the transaction and a clerk visually comparing the signature with a signature displayed on the credit card.

In recent years, terminal devices capable of inputting and displaying such a signature have been implemented by using smartphones and tablet devices. The smartphones and tablet devices are generally distributed as consumer devices, and thus it is possible to construct a payment terminal device by purchasing inexpensive consumer devices. In other words, if such a payment terminal device is constructed by using information terminals which are generally distributed as the consumer devices such as smartphones and tablet devices, it is possible to purchase an inexpensive payment terminal device itself. Further, since it is possible to generalize development platforms of applications (software) used in businesses other than the payment process, it is easy to reuse and divert development resources.

However, a “tamper-resistant property” required for safely performing a transaction by protecting the information of the customer is not provided in an information terminal that is designed on the assumption that it is used as a consumer device. The “tamper-resistant property” is a resistance against attacks attempting to steal information from the information terminal. A mobile device has been proposed, in which a portion related to the authentication information of the card used for the payment process, that is, a portion with a tamper-resistant property required as the payment terminal device is separated from the generic part in order to ensure the tamper-resistant property as a measure for the attacks attempting to steal information from the information terminal, for example, as depicted in US Patent Unexamined Publication No. 2010/0145854.

Even in a general terminal device, in particular, it is necessary to ensure information security when entering a personal identification number (PIN) such as a password. A banking system is known which includes a PIN PAD for encrypting a PIN input by a user in the payment process in order to ensure this type of tamper-resistant property, for example, as depicted in U.S. Pat. No. 8,376,219. For example, as depicted in Japanese Patent Unexamined Publication No. 2006-185449, a touch screen device is also known which encrypts and transmits information entered on the touch screen.

However, the information processing apparatus described above in the related art only protects the information regarding the card owner by encrypting the PIN and the card information.

In the information processing apparatus, a command interpreter that relays a payment process between an external payment target device and the information processing apparatus is provided, but if the command interpreter is replaced with an unauthorized application or is attacked by an unauthorized application, by a malicious third party, there is a possibility that an unforeseen disadvantage such as unauthorized selling occurs in a store. In other words, even if the store sells products or provides services to the counterpart that the store does not normally credit, there may be a loss of not recovering the money which is the price for goods and services.

In contrast, for example, when a contract for compensating a loss in a store by an acquirer has been made between the store and the acquirer (a company that recruits merchant agreements to deal with transactions of a particular credit card, and controls its credit sales), the loss occurs on the acquirer side as a result.

### SUMMARY OF THE INVENTION

A payment terminal device and payment processing method of the present disclosure ensure security of information regarding a payment process, and perform a suitable payment process, in a payment process of a transaction.

According to the present disclosure, there is provided a payment terminal device including an authentication information input unit that receives an input of authentication information, an execution environment providing unit that separately provides a secure execution environment with a tamper-resistant property and a non-secure execution environment without a tamper-resistant property, an input information management unit that is provided in the secure execution environment, and manages the authentication information which is input to the authentication information input unit, a relay unit that is provided in the non-secure execution environment and relays a payment process between an external payment target device and the payment terminal device, and a control unit that instructs the input information management unit and the relay unit to perform mutual authentication, in which when the mutual authentication is established, the input information management unit and the relay unit form a first secure communication path between the input information management unit and the relay unit, and after the first secure communication path is formed and a second secure communication path is formed between the payment target device and the relay unit, the relay unit relays the input information management unit and the payment target device through the first secure communication path and the second secure communication path, and performs transmission of payment process information regarding the payment process.

According to the present disclosure, there is provided a payment processing method of a payment terminal device including an authentication information input unit, the payment processing method including separately providing a secure execution environment with a tamper-resistant property and a non-secure execution environment without a tamper-resistant property, receiving authentication information in the authentication information input unit, managing the authentication information that is input, in an input information management unit that is provided in the secure execution environment, performing mutual authentication between a relay unit that is provided in the non-secure execution environment and the input information management unit, forming a first secure communication path between the input information management unit and the relay unit, when the mutual authentication is established, forming a second secure communication path between the relay unit and an external payment target device, and performing transmission of payment process information regarding a payment process by relaying the information processing apparatus and the payment target device through the first secure communication path and the second secure communication path, after the first secure communication path and the second secure communication path are formed, in the relay unit.

According to the present disclosure, the authentication information which is input to the authentication information input unit is managed by the input information management unit provided in the secure execution environment. The authentication information is transmitted to the relay unit through the first secure communication path that is formed between the relay unit provided in the non-secure execution environment and the input information management unit. The relay unit relays the payment process between the payment target device and the relay unit, through the second secure communication path formed between the relay unit and the external payment target device. When mutual authentication is established between the input information management unit and the relay unit, a first secure communication path is formed between the input information management unit and the relay unit, and after the first secure communication path is formed and a second secure communication path is formed between the payment target device and the relay unit, the relay unit relays the input information management unit and the payment target device through the first secure communication path and the second secure communication path and performs transmission of payment process information regarding the payment process. For example, when the relay unit is replaced with an unauthorized application, if the mutual authentication fails, the first secure communication path is not formed, and the procedure of the payment process fails. Thus, the security of the authentication information is ensured.

### BRIEF DESCRIPTION OF DRAWINGS

FIG. 1A is a front view illustrating an appearance of a payment terminal device of the present exemplary embodiment;

FIG. 1B is a side view illustrating an appearance of the payment terminal device illustrated in FIG. 1A;

FIG. 2 is a block diagram specifically illustrating an example of a hardware configuration of the payment terminal device of the present exemplary embodiment;

FIG. 3 is a block diagram specifically illustrating an example of a system configuration mainly indicating software functions of the payment terminal device of the present exemplary embodiment;

FIG. 4 is a flowchart specifically illustrating an operation procedure during a payment process of the payment terminal device of the present exemplary embodiment; and

FIG. 5 is a flowchart specifically illustrating an operation procedure during the payment process of the payment terminal device of the present modification.

### DETAILED DESCRIPTION OF THE PREFERRED EMBODIMENTS

Hereinafter, exemplary embodiments of the present disclosure will be described with reference to the drawings. In the following present exemplary embodiment, a payment terminal device used during a payment process in transactions of goods or services will be described as an example of a payment terminal device according to the present disclosure. The present disclosure may be implemented by a computer-readable recording medium for causing an information processing apparatus to perform operations of a payment processing method, or a program causing the information processing apparatus to perform operation of the payment processing method.

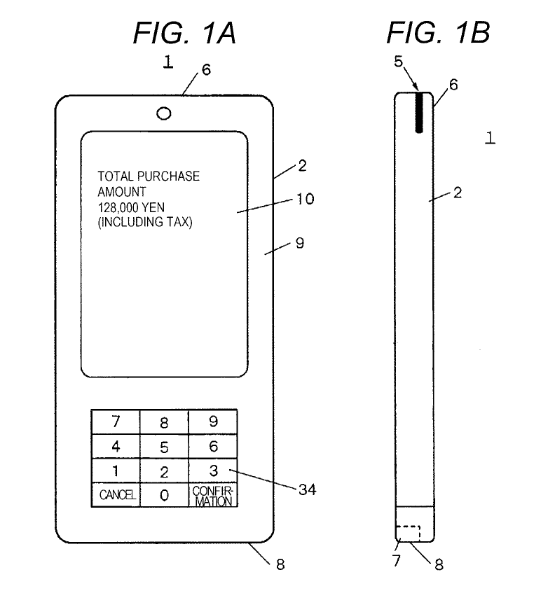

FIG. 1A is a front view illustrating an appearance of payment terminal device 1 of the present exemplary embodiment. FIG. 1B is a side view illustrating an appearance of payment terminal device 1 illustrated in FIG. 1A. Payment terminal device 1 of the present exemplary embodiment is portable, and is configured to include information processing unit 2 that performs various information processes including a payment process in transactions of, for example, goods or services.

In the following description, “secure” means a payment terminal device has a tamper-resistant property necessary for man-in-the-middle attacks from third parties (malicious third parties, viruses such as malware, or unauthorized applications) against information, and “non-secure” means not having such a tamper-resistant property.

Payment terminal device 1 illustrated in FIG. 1A includes, for example, slit 5 which is a path through which a magnetic card slides for reading card information recorded in the magnetic card, on the upper surface 6 of information processing unit 2. Payment terminal device 1 includes, for example, insertion opening 7 into which a contact type IC card is inserted for reading the card information recorded in the contact type IC card, in the lower surface 8 of information processing unit 2. Payment terminal device 1 includes, for example, loop antenna 38 for reading the card information recorded in a non-contact type IC card, inside payment terminal device 1.

Payment terminal device 1 includes touch panel 10 functioning as an example of the input unit and the display unit, in front surface 9 of information processing unit 2 (see FIG. 1A).

(Hardware Configuration of Payment Terminal Device)

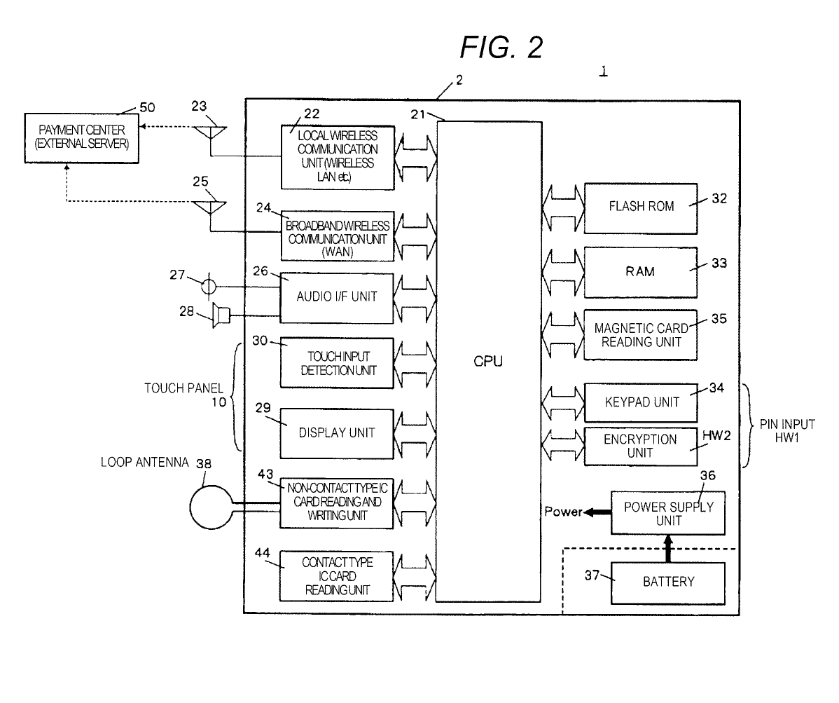

FIG. 2 is block diagram specifically illustrating an example of a hardware configuration of payment terminal device 1 of the present exemplary embodiment. Payment terminal device 1 illustrated in FIG. 2 includes CPU 21, local wireless communication unit 22 connected to local wireless communication antenna 23, broadband wireless communication unit 24 connected to broadband wireless communication antenna 25, audio I/F (interface) unit 26 connected to microphone 27 and speaker 28, display unit 29, touch input detection unit 30, flash ROM 32, RAM 33, magnetic card reading unit 35, keypad unit 34, encryption unit HW2, power supply unit 36, battery 37, non-contact type IC card reading and writing unit 43 connected to loop antenna 38, and contact type IC card reading unit 44.

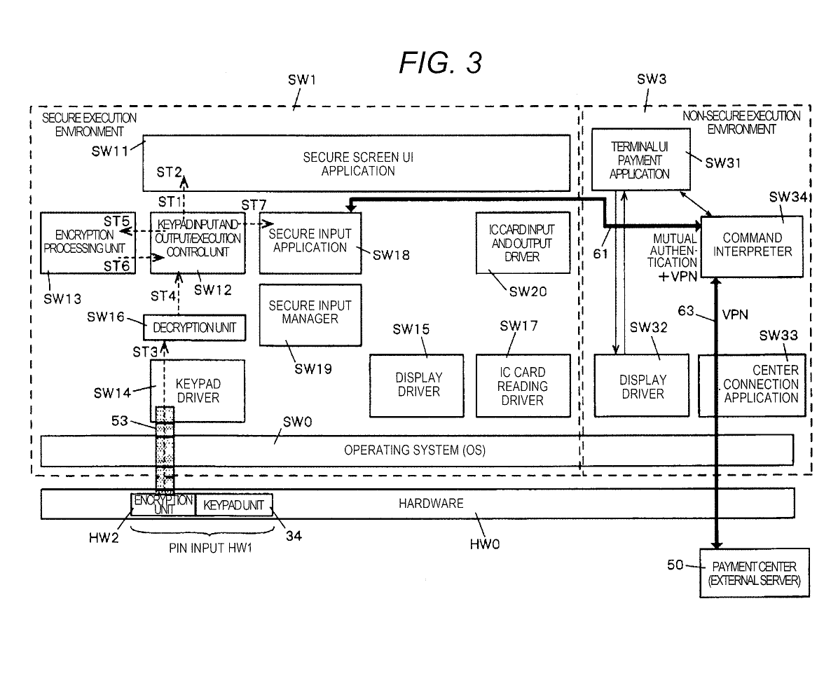

As illustrated in FIG. 3, payment terminal device 1 separately provides a virtual secure execution environment and a virtual non-secure execution environment so as to independently operate in parallel, for example, in operating system (OS) SW0 that can be implemented by using CPU 21. Operating system (OS) SW0 provides, for example, the secure execution environment and the non-secure execution environment, by using, for example, a virtual machine (VM).

Information processing unit 2 of payment terminal device 1 includes central processing unit (CPU) 21 that controls overall processes of respective units of payment terminal device 1 illustrated in FIG. 2. In FIG. 2, respective units of payment terminal device 1 are connected to CPU 21.

Local wireless communication unit 22 is connected to local wireless communication antenna 23, and performs, for example, wireless communication in a wireless local area network (LAN), by using a local wireless communication path which is not illustrated. Local wireless communication is not limited to, for example, the wireless LAN, and may be Bluetooth (registered mark) and others.

Broadband wireless communication unit 24 is connected to broadband wireless communication antenna 25, and performs broadband wireless communication, by using a broadband wireless communication path (WAN: wide area network) which is not illustrated. It is possible to use communication by for example, a mobile phone line such as wideband code division multiple access (W-CDMA), universal mobile telecommunications system (UMTS), code division multiple access (CDMA) 2000, and long term evolution (LTE), for broadband wireless communication.

Local wireless communication unit 22 and broadband wireless communication unit 24 are respectively capable of wirelessly communicating with external server that is payment center 50.

Audio I/F unit 26 is connected to microphone 27 and speaker 28, and controls the input and output of audio. In addition, payment terminal device 1 can communicate with other mobile phones and fixed line phones by using microphone 27, speaker 28, audio I/F unit 26, and broadband wireless communication unit 24. Speaker 28 may explicitly notify a user that payment terminal device 1 is in a state of a secure mode or a state of a non-secure mode described later, in response to an instruction from CPU 21, or may output an alarm sound for drawing attention from the user or an alarm sound indicating operation errors, when the user operates payment terminal device 1.

Display unit 29 includes, for example, a liquid crystal display (LCD) or an organic electroluminescence (EL), and displays information or data of which display is instructed by CPU 21, on touch panel 10 illustrated in FIGS. 1A and 1B. Touch input detection unit 30 detects a touch input on touch panel 10 by the user (for example, a clerk in a credit card member store (for example, store; hereinafter referred to as a member store) who handles a credit card transaction, and a customer who purchases goods in the store).

Flash read only memory (ROM) 32 stores various types of data. The stored data may be, for example, data regarding a business, or a program for controlling an operation of payment terminal device 1 (mainly, information processing unit 2). Further, the program includes various programs relating to the operations of payment terminal device 1 such as application (software) for the payment process. Therefore, flash ROM 32 has a function as a recording medium for recording a program.

Random access memory (RAM) 33 is a work memory used to temporarily store processing data generated during a calculation process involved with the operation of payment terminal device 1 (mainly, information processing unit 2). Further, a secure flag (for example, “True” or “False”) indicating whether or not payment terminal device 1 is in a state of a secure mode to be described later or a non-secure flag (for example, “True” or “False”) indicating whether or not payment terminal device 1 is in a state of a non-secure mode is assigned to a specific area of RAM 33.

PIN input unit HW1 is configured to include keypad unit 34 and encryption unit HW2. Keypad unit 34 corresponds to keypad unit 34 of personal identification number (PIN) input unit HW1 which is an example of an authentication information input unit provided in hardware HW0 illustrated in FIG. 3, and receives key input from the user. Encryption unit HW2 encrypts PIN information which is input from keypad unit 34. An encryption key used for encryption by encryption unit HW2 is, for example, a common key shared with decryption unit SW16. However, the encryption key is not limited to the common key.

Magnetic card reading unit 35 is placed inside of a slit 5 illustrated in FIGS. 1A and 1B, and reads a magnetic stripe as card information that is printed on the magnetic card. The card information that is read by magnetic card reading unit 35 is input to CPU 21.

Non-contact type IC card reading and writing unit 43 is connected to loop antenna 38, and reads card information recorded in a non-contact type IC card. The card information that is read by non-contact type IC card reading and writing unit 43 is input to CPU 21.

Contact type IC card reading unit 44 is placed inside of insertion opening 7 illustrated in FIGS. 1A and 1B, and reads card information recorded on a contact type IC card through an electrode of the contact type IC card that is inserted into insertion opening 7. The card information that is read by contact type IC card reading unit 44 is input to CPU 21.

Power supply unit 36 is mainly a power source of information processing unit 2, receives power accumulated in battery 37 and supplies power to respective units including CPU 21 in information processing unit 2. CPU 21 controls power supply unit 36 so as to be able to perform or stop power supply to some or all of circuits constituting information processing unit 2. The power supply destinations of power supply unit 36 are respective units such as local wireless communication unit 22, broadband wireless communication unit 24, display unit 29, touch input detection unit 30, non-contact type IC card reading and writing unit 43, contact type IC card reading unit 44, keypad unit 34, encryption unit HW2, and magnetic card reading unit 35, in addition to CPU 21.

Payment terminal device 1 having the configuration described above has the following characteristics. In the present exemplary embodiment, information processing unit 2 includes touch panel 10 including display unit 29 and touch input detection unit 30 (see FIGS. 1A and 1B and FIG. 2), and local wireless communication unit 22 or broadband wireless communication unit 24 that is capable of communicating with an external connection destination device (for example, payment center 50).

In recent years, the contact type IC card, the non-contact type IC card, and electronic money have been added into the magnetic card which has generally been used for payment in a transaction using a card, such that payment schemes in the transaction using a card are diversified. Due to the addition of the payment schemes, the development costs and prices of payment terminal device 1 have increased. Here, if information processing unit 2 is a consumer device that is generally distributed, such as smartphones and tablet terminals, the price of payment terminal device 1 itself can become cheaper, and thus an increase in the development costs of payment terminal device 1 is suppressed to a minimum.

In this case, a general-purpose OS (for example, see operating system (OS) SW0 illustrated in FIG. 3) is employed as a software platform in information processing unit 2. Therefore, since the development platforms of applications for payment (payment application) and applications which are used in other businesses (hereinafter referred to as “business application”) are generalized, it is easy to re-use and divert development resources. Further, if it is possible to use a consumer device to constitute information processing unit 2, information processing unit 2 has such a high calculation processing capability that video recording and playback are possible without stress, and thus the payment application and the business application can be flexibly operated without stress.

(System Configuration Mainly Indicating Software Functions of Payment Terminal Device)

FIG. 3 is a block diagram specifically illustrating an example of a system configuration mainly indicating software functions of payment terminal device 1 of the present exemplary embodiment. In FIG. 3, respective operations executed in CPU 21 of information processing unit 2 of payment terminal device 1 are blocks mainly indicating software functions. Specifically, respective functions of operating system (OS) SW0, secure screen UI application SW11, keypad input and output/execution control unit SW12, encryption processing unit SW13, keypad driver SW14, display driver SW15, decryption unit SW16, IC card input and output driver SW20, IC card reading driver SW17, secure input application SW18, secure input manager SW19, terminal UI payment application SW31, display driver SW32, center connection application SW33, and command interpreter SW34 are executed (implemented) in CPU 21. Further, in FIG. 3, reference symbols ST1 to ST7 represent a procedure of a process regarding PIN information that is input by PIN input unit HW1, in a secure execution environment.

Since payment terminal device 1 of the present exemplary embodiment uses a virtualization application in operating system (OS) SW0, secure execution environment SW1 and non-secure execution environment SW3 are separately provided so as to independently operate in parallel, to hardware HW0 of payment terminal device 1.

Secure execution environment SW1 includes secure screen UI application SW11, keypad input and output/execution control unit SW12, encryption processing unit SW13, keypad driver SW14, display driver SW15, IC card input and output driver SW20, IC card reading driver SW17, secure input application SW18, secure input manager SW19, and operating system (OS) SW0.

Operating system (OS) SW0 which is an example of an execution environment providing unit is basic software that manages a secure execution environment and a non-secure execution environment, for example, Windows (registered trademark) or Linux (registered trademark).

Keypad driver SW14 controls the operation of keypad unit 34, receives encrypted PIN from PIN input unit HW1 through secure transmission path 53, and outputs the encrypted PIN to keypad input and output/execution control unit SW12 through decryption unit SW16. Here, secure communication path 53 is formed as a private communication path by PIN input unit HW1 and keypad driver SW14 therebetween.

Decryption unit SW16 shares a common key with encryption unit HW2 of PIN input unit HW1, and decrypts the encrypted PIN that is output from keypad driver SW14. Decryption unit SW16 outputs PIN information that is obtained by decryption, to keypad input and output/execution control unit SW12. Incidentally, with respect to delivery of the encrypted PIN between PIN input unit HW1 and encryption unit HW2, encryption/decryption may be performed by an encryption method using a public key instead of the common key.

Keypad input and output/execution control unit SW12 controls the management of the input and output of the authentication information that is output from keypad driver SW14 through decryption unit SW16, and the execution of the operation regarding the input and output of the PIN information.

Keypad input and output/execution control unit SW12 compares the PIN information that is output from keypad driver SW14 with the PIN information that is registered in the IC card, and as result of the comparison, when it is determined that the PIN information pieces match, keypad input and output/execution control unit SW12 outputs PIN information to encryption processing unit SW13, and causes encryption processing unit SW13 to encrypt the PIN information.

Encryption processing unit SW13 which is an example of an encryption unit includes an encryption key that can be decrypted in payment center 50 and encrypts the PIN information that is output from keypad input and output/execution control unit SW12 by using the encryption key, and outputs encrypted PIN information to keypad input and output/execution control unit SW12. In addition, the encryption process may be an encryption using a common key method using the same key as in payment center 50, or an encryption using a public key encryption method in which encryption processing unit SW13 and payment center 50 respectively have their own private keys, and a public key of the counterpart.

Secure screen UI application SW11 displays a display screen that receives secure information, on touch panel 10, in response to an instruction from keypad input and output/execution control unit SW12. Specifically, secure screen UI application SW11 displays a message for prompting a user to input the PIN information, and displays an asterisk (*) in units of digits in order to hide the input PIN information.

Display driver SW15 controls an operation of display unit 29 constituting touch panel 10 so as to obtain, for example, data of characters or images that are output from keypad input and output/execution control unit SW12 and secure screen UI application SW11, and display the obtained data on display unit 29.

IC card reading driver SW17 controls the operations of contact type IC card reading unit 44 and non-contact type IC card reading and writing unit 43, and transmits the card information that is read to IC card input and output driver SW20. Individual IC card reading driver SW17 may be respectively implemented on non-contact type IC card reading and writing unit 43 and contact type IC card reading unit 44.

IC card input and output driver SW20 outputs the card information that is output from IC card reading driver SW17, to keypad input and output/execution control unit SW12.

Secure input application SW18 that is an example of an input information management unit receives an instruction from command interpreter SW34, and receives and manages the encrypted PIN information from keypad input and output/execution control unit SW12. Secure input application SW18 performs mutual authentication with command interpreter SW34 provided in non-secure execution environment SW3. When the mutual authentication is established, secure input application SW18 forms secure virtual communication path (VPN: virtual private network, hereinafter, referred to as “VPN”) 61 between command interpreter SW34 and secure input application SW18, and transmits (inputs and outputs) payment-related information containing the encrypted PIN information.

While the mutual authentication is not performed between secure input application SW18 and command interpreter SW34, VPN 61 may be formed between secure input application SW18 and command interpreter SW34.

Secure input manager SW19 that is an example of a control unit monitors whether the mutual authentication is established between secure input application SW18 and command interpreter SW34, or whether secure input application SW18 can operate in a secure state, and the like.

Next, terminal UI payment application SW31, display driver SW32, center connection application SW33, command interpreter SW34, and operating system (OS) SW0 are provided in non-secure execution environment SW3.

Terminal UI payment application SW31 displays a display screen that receives non-secure information, on touch panel 10. For example, terminal UI payment application SW31 displays various types of information in the payment process, and receives various types of input operations. Then, terminal UI payment application SW31 instructs command interpreter SW34 to start the transmission of payment-related information (described later). Payment center 50 may instruct command interpreter SW34 to start the transmission of payment-related information.

Display driver SW32 controls the operation of display unit 29 constituting touch panel 10 so as to obtain, for example, data of payment screens, characters or images that are output from keypad input and output/execution control unit SW12 and terminal UI payment application SW31, and display the obtained data on display unit 29.

Center connection application SW33 instructs local wireless communication unit 22 or broadband wireless communication unit 24 to transmit payment-related information such as the encrypted PIN information, card information (for example, the card issuing company, the corresponding brand, and the card number of an IC card), and sales process information (for example, the payment amount and the payment method) which are output from command interpreter SW34, to payment center 50 which is a connection destination device and like.

Command interpreter SW34 that is an example of a relay unit performs mutual authentication between secure input application SW18 that is provided in secure execution environment and command interpreter SW34, forms secure VPN (virtual communication path) 61 when mutual authentication is established, and transmits payment-related information containing the encrypted PIN information. Further, command interpreter SW34 forms secure VPN (virtual private communication path) 63 between external payment center (external server) 50 that is a payment target device and command interpreter SW34, and transmits the payment-related information through VPN 63. The payment-related information contains the payment amount, the payment method, the encrypted PIN information, and the like.

(Operation Procedure of Payment Terminal Device 1 During Payment Process)

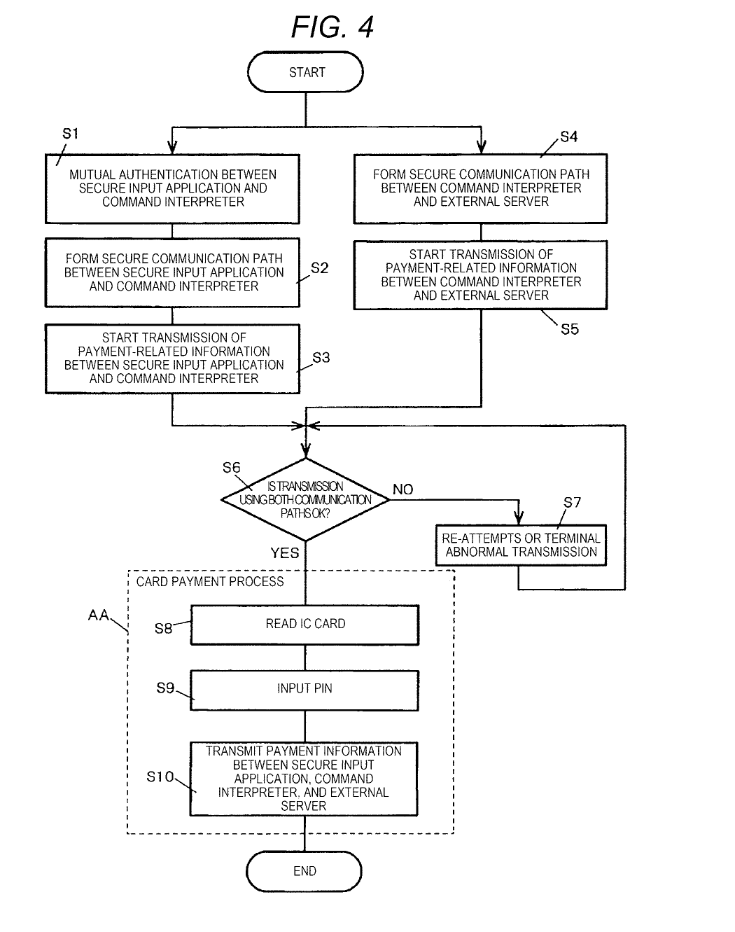

Next, the operation of payment terminal device 1 of the present exemplary embodiment during the payment process will be described with reference to FIG. 4. FIG. 4 is a flowchart specifically illustrating an operation procedure during the payment process of payment terminal device 1 of the present exemplary embodiment. If terminal UI payment application SW31 (see FIG. 3) that is installed in information processing unit 2 of payment terminal device 1 (see FIGS. 1A and 1B and FIG. 2) is started, terminal UI payment application SW31 allows command interpreter SW34 to start a procedure of the payment process.

In FIG. 4, first, secure input application SW18 and command interpreter SW34 start mutual authentication, in response to an instruction from secure input manager SW19 (S1). Since a mutual authentication method is a known technology, a description thereof will be omitted.

When the mutual authentication of step S1 is established, secure input application SW18 and command interpreter SW34 form secure virtual communication path (VPN: virtual private network, hereinafter, referred to as “VPN”) 61 between secure input application SW18 and command interpreter SW34 (S2).

Command interpreter SW34 instructs secure input application SW18 to start transmission of the payment-related information such as the encrypted PIN information, the card information (for example, the card issuing company, the corresponding brand, and the card number of the IC card) that is managed by secure input application SW18. In response to an instruction, the transmission of the payment-related information containing the encrypted PIN information is securely performed between secure input application SW18 and command interpreter SW34 through VPN 61 (S3).

In parallel with the operations of steps S1 to S3, in response to an instruction from secure input manager SW19, command interpreter SW34 forms secure virtual communication path (VPN: virtual private network, hereinafter, referred to as “VPN”) 63 between command interpreter SW34 and payment center (external server) 50 (S4).

Terminal UI payment application SW31 instructs command interpreter SW34 to start the transmission of the payment-related information. In response to the instruction, the transmission of the payment-related information is securely performed between command interpreter SW34 and payment center (external server) 50 through VPN 63 (S5).

If the transmission is started in steps S3 and S5, secure input manager SW19 determines whether or not the transmission using VPNs 61 and 63 is normal (OK) (S6). When the transmission is abnormal (NG), secure input manager SW19 attempts the transmission again to secure input application SW18 (S7). After a predetermined number of attempts, when the transmission is abnormal, the operation is forcefully terminated.

In contrast, when the transmission is normal, a card payment process indicated by dotted line AA is performed in which command interpreter SW34 is relayed.

If terminal UI payment application SW31 receives the inputs of payment amount information and a payment method, it displays a message for prompting a reading operation of a card on a screen of touch panel 10 (see ST1 and ST2 in FIG. 3).

IC card input and output driver SW20 reads an IC card by an operation of either insertion of a contact type IC card into insertion opening 7 or moving a non-contact type IC card close to front surface 9 of payment terminal device 1 (S8).

Secure screen UI application SW11 displays a message for prompting the user to input the PIN information on touch panel 10.

Keypad input and output/execution control unit SW12 receives PIN information that is input by PIN input unit HW1 through keypad driver SW14 and decryption unit SW16 (S9, see ST3 and ST4 in FIG. 3). The PIN information is input to keypad input and output/execution control unit SW12.

As a first operation procedure of the payment process requiring PIN comparison, keypad input and output/execution control unit SW12 outputs PIN information that is input in step S9, to encryption processing unit SW13, and causes encryption processing unit SW13 to encrypt the information (S10, see ST5 in FIG. 3).

Encryption processing unit SW13 encrypts the PIN information that is output from keypad input and output/execution control unit SW12 by using an encryption key that can be decrypted in payment center 50, and outputs the encrypted PIN information, to keypad input and output/execution control unit SW12 (see ST6 in FIG. 3).

Secure input manager SW19 allows secure input application SW18 to acquire encrypted PIN information that is encrypted and generated by encryption processing unit SW13 and information regarding the IC card that is read in step S8, from keypad input and output/execution control unit SW12 (see ST7 in FIG. 3), and allows command interpreter SW34 that is in the non-secure execution environment through VPN 61 to transmit the encrypted PIN information and the information regarding the IC card. The information regarding the IC card (for example, the card issuing company, the corresponding brand, and the card number of the IC card) that is read in step S8 may be or may not be encrypted. The encryption of the information regarding the IC card may be performed by encryption processing unit SW13, and another encryption processing unit which is not illustrated.

Command interpreter SW34 receives the encrypted PIN information and the information regarding the IC card, and performs transmission with external payment center 50 (or an acquirer, hereinafter, the same) through secure VPN 63 (510). Payment center 50 decrypts the PIN information received from command interpreter SW34 of payment terminal device 1, and compares the PIN information that is managed by payment center 50 with the decrypted PIN information. When the two pieces of PIN information match, and it is confirmed that the card to be compared has no problem for transaction (for example, it is not on a black list), payment center 50 gives credit to command interpreter SW34 through center connection application SW33 of payment terminal device 1. Command interpreter SW34 of payment terminal device 1 receives credit of payment center 50, performs a sales process which is the next payment process, and terminates communication with payment center 50.

Command interpreter SW34 of payment terminal device 1 may perform transmission of the sales process data to payment center 50 from after the completion of the sales process to before the completion of communication with payment center 50, and transmission may be performed later in conjunction with the sales process data of another payment. The transmission of the sales process data is performed through VPN 63. After the IC card is read in step S8 and the PIN information is input in step S9, the VPN 63 may be formed. Otherwise, VPN 63 may be formed after acquiring a comparison result indicating that the PIN information input in step S9 and the PIN information registered in the IC card read in step S8 match. When two pieces of PIN information do not match or it is confirmed that the card to be compared has no problem for transaction (for example, it is not on a black list), payment center 50 notifies command interpreter SW34 of payment terminal device 1 that credit is not given. After receiving the notification, command interpreter SW34 of payment terminal device 1 does not perform the sales process and stops the payment process.

As described above, in the first operation procedure of the payment process, command interpreter SW34 provided in the non-secure execution environment of payment terminal device 1 of the present exemplary embodiment is securely connected to secure input application SW18 by VPN 61 for which mutual authentication is performed, and is securely connected to external payment center 50 by VPN 63.

Accordingly, when, for example, command interpreter SW34 of payment terminal device 1 is replaced with an unauthorized application by a malicious third party's attack, since mutual authentication fails between secure input application SW18 and command interpreter SW34, the procedure of the payment process fails. In this manner, since command interpreter SW34 is replaced with an unauthorized application and the payment process is not performed, payment terminal device 1 can perform a correct payment process in transaction.

As a result, according to payment terminal device 1 of the present exemplary embodiment, selling products or providing services does not occur and a loss does not occur in which the price cannot be recovered for the counterpart that the store inherently does not give credit. Even when a contract to compensate for loss in a store is made between a store and an acquirer, the loss does not occur on the acquirer side.

Since payment terminal device 1 of the present exemplary embodiment securely transmits the encrypted PIN information through virtual private communication path (VPN) 61 formed when mutual authentication is established, between secure input application SW18 and command interpreter SW34, it is possible to ensure security of PIN information.

In contrast, as a second operation procedure in a payment process requiring PIN comparison, IC card input and output driver SW20 reads an IC card by an operation of either insertion of a contact type IC card into insertion opening 7 or making a non-contact type IC card close to front surface 9 of payment terminal device 1 (S8).

Secure screen UI application SW11 displays a message prompting the user to input the PIN information on touch panel 10.

Keypad input and output/execution control unit SW12 receives PIN information that is input by PIN input unit HW1, through keypad driver SW14 and decryption unit SW16 (S9, see ST3 and ST4 in FIG. 3).

Keypad input and output/execution control unit SW12 outputs PIN information that is input in step S9, to secure input application SW18. Secure input application SW18 outputs the PIN information that is input from keypad input and output/execution control unit SW12, to the IC card (not illustrated), through IC card input and output driver SW20 and IC card reading driver SW17. When the PIN information that is input in step S9 is output from keypad input and output/execution control unit SW12 to secure input application SW18, an IC card that is read in step S8 may be encrypted by a decryption-capable key.

With respect to the IC card, the PIN information that is registered in the IC card and the PIN information that is input in step S9 are compared, and the comparison result of the PINs is output. If the IC card that is read in step S8 is a non-contact type, payment terminal device 1 displays the PIN information that is input on display unit 29 of touch panel 10 such that the user holds up the IC card at a position where communication with loop antenna 38 is possible. Otherwise, payment terminal device 1 has a structure and performs a process of continuously placing the IC card at a position where communication with loop antenna 38 is possible while the IC card is read in step S8, the PIN information is input in step S9, and the comparison result of PIN information from the IC card is obtained.

Secure input application SW18 receives a comparison result of the PIN which is output from the IC card through IC card input and output driver SW20 and IC card reading driver SW17. If a comparison result indicating that the PIN information input in step S9 and PIN information registered in the IC card that is read in step S8 match each other is obtained from the IC card, secure input application SW18 instructs command interpreter SW34 to perform a sales process which is the subsequent payment process. At the same time as the instruction of the sales process, secure input application SW18 may transmit information required for the sales process, to command interpreter SW34. The instruction of the sales process and the transmission of the information required for the sales process are performed through VPN 61 that is formed by mutual authentication which is previously described in the on-line payment. When the mutual authentication fails during the formation of VPN 61, or secure input application SW18 obtains the comparison result indicating two PINs match, secure input application SW18 does not instruct command interpreter SW34 to perform the sales process. Command interpreter SW34 does not perform the sales process and the subsequent procedure of the payment process is stopped.

When acquiring a comparison result indicating that the PIN information input in step S9 and the PIN information registered in the IC card read in step S8 match, command interpreter SW34 of payment terminal device 1 performs the sales process that is the subsequent process. Command interpreter SW34 may perform transmission of the sales process data to payment center 50 from after the completion of the sales process to before the completion of communication with payment center 50, or may perform the transmission later in conjunction with the sales process data of another payment. The transmission of the sales process data is performed through VPN 63. After the IC card is read in step S8 and the PIN information is input in step S9, VPN 63 may be formed. Otherwise, VPN 63 may be formed even after acquiring a comparison result indicating that the PIN information input in step S9 and the PIN information registered in the IC card read in step S8 match.

As described above, in the second operation procedure of the payment process, in payment terminal device 1 of the present exemplary embodiment, command interpreter SW34 provided in non-secure execution environment SW3 is securely connected to secure input application SW18 by VPN 61 for which mutual authentication is performed, and is securely connected to external payment center 50 by VPN 63.

Accordingly, in payment terminal device 1, for example, when command interpreter SW34 is replaced with an unauthorized application due to an attack by a malicious third party, mutual authentication between secure input application SW18 and command interpreter SW34 fails, and thus the procedure of the payment process fails. In this manner, in payment terminal device 1, it does not occur that command interpreter SW34 is replaced with an unauthorized application and is subjected to the payment process, such that it is possible to perform a correct payment process in transaction.

As a result, according to payment terminal device 1 of the present exemplary embodiment, selling products or providing services does not occur in other parties to which a store does not give credit inherently, and the loss of not recovering money does not occur. Further, even if the store and the acquirer make a contract to compensate for a loss in the store, the loss does not occur on the acquirer side.

Since payment terminal device 1 of the present exemplary embodiment securely performs instruction of the sales process between secure input application SW18 and command interpreter SW34, through VPN 61 which is established when mutual authentication is established, it is possible to secure security of the sales process.

(Modification of the Present Exemplary Embodiment)

In the present exemplary embodiment described above, virtual private communication path (VPN) 61 between secure input application SW18 and command interpreter SW34 and virtual private communication path (VPN) 63 between command interpreter SW34 and external payment center 50 are formed in a parallel operation.

In a modification of the present exemplary embodiment (hereinafter, it is referred to as “the present modification”), a case will be described in which VPN 61 between secure input application SW18 and command interpreter SW34, and VPN 63 between command interpreter SW34 and external payment center 50 are formed in time-series.

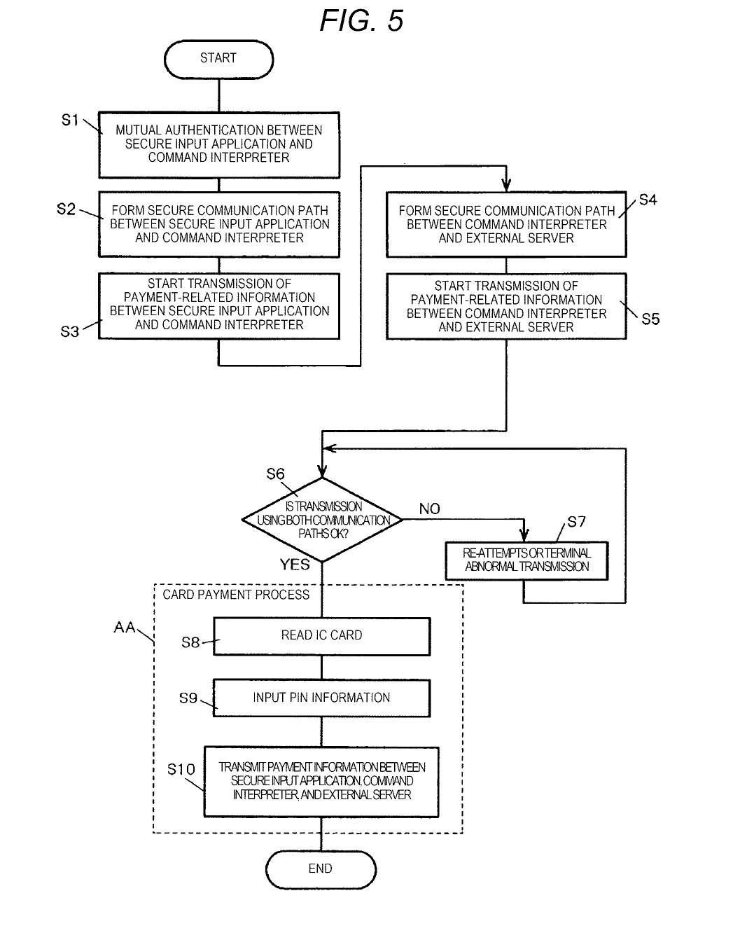

FIG. 5 is a flowchart specifically illustrating an operation procedure during the payment process of the payment terminal device 1 of the present modification. Since same step processes as those in FIG. 4 are denoted by same step numbers, description thereof will be omitted.

In FIG. 5, secure input manager SW19 forms VPN 61 between secure input application SW18 and command interpreter SW34 after the completion of the process in steps S1 to S3, and thereafter, forms VPN 63 between command interpreter SW34 and external payment center 50 after the completion of the process in steps S4 and S5.

As described above, in the modification, payment terminal device 1 sequentially forms VPN 61 between secure input application SW18 and command interpreter SW34, and VPN 63 between command interpreter SW34 and external payment center 50, such that it is possible to reduce the processing load during formation of the VPN, and implement the VPN with relatively inexpensive hardware.

Various exemplary embodiments have been described with reference to the drawings, but it goes without saying that the present disclosure is not limited to the embodiments. It is clear that those skilled in the related art can conceive various changes and modifications within the scope described in the claims, and it is understood that those of course belong to the technical scope of the present disclosure.

For example, since the present exemplary embodiment and the modification use a virtualization application in one operating system (OS) SW0, secure execution environment SW1 and non-secure execution environment SW3 are separately provided to hardware HW0 of payment terminal device 1 such that they operate independently and in parallel.

In payment terminal device 1 of the present disclosure, a virtualization hypervisor separately provides a secure virtual machine (Secure VM) providing secure execution environment SW1 and a non-secure virtual machine (Non-Secure VM) providing non-secure execution environment SW3, to hardware HW0 of payment terminal device 1, a first guest operating system (OS) controlling a secure virtual machine is included in the secure virtual machine and a second guest operating system (OS) controlling a non-secure virtual machine is included in the non-secure virtual machine.

In the exemplary embodiment, the secure execution environment and the non-secure execution environment are implemented by the same CPU, but may be implemented by separate CPUs.

The present disclosure can be applied to devices requiring various secure inputs, such as ATM devices in a bank as well as the payment terminal device.

What is claimed is:

1. A payment terminal device comprising:
an authentication information input unit that receives an input of authentication information;
an execution environment providing unit that separately provides a secure execution environment with a tamper-resistant property and a non-secure execution environment without a tamper-resistant property;
an input information management unit that is provided in the secure execution environment, and manages the authentication information which is input to the authentication information input unit;
a relay unit that is provided in the non-secure execution environment and relays a payment process between an external payment target device and the payment terminal device; and
a control unit that instructs the input information management unit and the relay unit to perform mutual authentication,
wherein when the mutual authentication is established, the input information management unit and the relay unit form a first secure communication path between the input information management unit and the relay unit, and
wherein after the first secure communication path is formed and a second secure communication path is formed between the payment target device and the relay unit, the relay unit relays the input information management unit and the payment target device through the first secure communication path and the second secure communication path, and performs transmission of payment process information regarding the payment process.

2. A payment processing method of a payment terminal device including an authentication information input unit, the payment processing method comprising:
separately providing a secure execution environment with a tamper-resistant property and a non-secure execution environment without a tamper-resistant property;
receiving authentication information in the authentication information input unit;
managing the authentication information that is input, in an input information management unit that is provided in the secure execution environment;
performing mutual authentication between a relay unit that is provided in the non-secure execution environment and the input information management unit;
forming a first secure communication path between the input information management unit and the relay unit, when the mutual authentication is established;
forming a second secure communication path between the relay unit and an external payment target device; and
performing transmission of payment process information regarding a payment process by relaying the information processing apparatus and the payment target device through the first secure communication path and the second secure communication path, after the first secure communication path and the second secure communication path are formed, in the relay unit.
